(19) United States
(12) Patent Application Publication
(10) Pub. No.: US 2025/0254347 A1
(43) Pub. Date: Aug. 7, 2025

(54) METHOD FOR VIDEO DATA GENERATION AND STORAGE, CAMERA DEVICE, AND VIDEO SURVEILLANCE SYSTEM

(71) Applicant: Shenzhen Reolink Technology Co., Ltd., Shenzhen (CN)

(72) Inventor: Guobin Lin, Shenzhen (CN)

(21) Appl. No.: 19/187,024

(22) Filed: Apr. 23, 2025

(30) Foreign Application Priority Data
Apr. 28, 2024 (CN) 202410524479.2

(51) Int. Cl. H04N 19/436; G06V 20/52; H04N 19/184

(52) U.S. Cl. CPC H04N 19/436; G06V 20/52; H04N 19/184

(57) ABSTRACT

The present application provides a method for video data generation and storage, a camera device, and a video surveillance system. The camera device includes an image capturing unit, a video encoding unit, and a controller. The video encoding unit encodes an image captured by the image capturing unit with a first resolution, a first frame rate and a first bitrate to obtain a first bitstream, and performs parallel encoding on the image with a second resolution, a second frame rate and a second bitrate to obtain a second bitstream. The controller encapsulates the first bitstream into a first video and store the first video to a storage unit, and encapsulates the second bitstream into a second video when detecting an intrusion target in a monitored area, and store the second video to the storage unit. The storage space occupied by video data captured from the system is effectively reduced.

### TECHNICAL FIELD

This application relates to the technical field of security surveillance, and particularly relates to a method for video data generation and storage, a camera device, and a video surveillance system.

### BACKGROUND

With the development of computer technology and Internet technology, cameras are widely used in various security monitoring systems. Video recording of monitored areas by the camera devices is significant for modern security systems, which can not only provide real-time monitoring and subsequent investigation functions, but also offer deeper support for security management through intelligent analysis.

After the video recording of the monitored areas by the camera devices, the obtained video data is typically stored in a storage unit for subsequent investigation. Frame rate is a key parameter affecting video smoothness, the higher the frame rate, the better the smoothness of videos. Resolution is a key parameter affecting video quality, the higher the resolution, the better the video quality and the clearer the video image. For videos of the same duration and resolution, the higher the frame rates, the larger the storage space occupation. For videos of the same duration and frame rate, the higher the resolutions, the larger the storage space occupation. How to reduce the storage space occupied by the videos to enable storage units to store longer duration videos is a problem.

### SUMMARY

The present application provides a method for video data generation and storage, a camera device, and a video surveillance system, aiming to solve the problem of large storage space occupation by mounts of video data captured from the video surveillance system.

According to an aspect of the embodiments of the present application, a method for video data generation and storage is provided, which includes: capturing an image of a monitored area by an image capturing unit of the camera device; controlling a video encoding unit of a camera device to encode the image with a first resolution, a first frame rate and a first bitrate to obtain a first bitstream; controlling the video encoding unit to perform parallel encoding on the image with a second resolution, a second frame rate and a second bitrate to obtain a second bitstream, wherein the second resolution is greater than the first resolution, the second frame rate is greater than or equal to the first frame rate, and the second bitrate is greater than the first bitrate; encapsulating the first bitstream into a first video and storing the first video to a storage unit; and encapsulating the second bitstream into a second video when detecting an intrusion target in a monitored area, and storing the second video to the storage unit.

In an alternative, the camera device includes a first buffer for temporarily storing the first video bitstream, and the method further includes: storing the first bitstream to the first buffer; if the first buffer is insufficient to store the first bitstream, overwriting the earliest first bitstream stored in the first buffer with the first bitstream to be stored; or removing the earliest stored data from the first buffer, and storing the first bitstream in the first buffer.

In an alternative, the storage unit is a memory card of the camera device, and the encapsulating the first bitstream into a first video and storing the first video to a storage unit includes: acquiring the first bitstream from the first buffer; encapsulating the first bitstream into the first video; and storing the first video to the memory card.

In an alternative, the method further includes: in response to a request for real-time viewing of the first bitstream sent by an electronic device, acquiring the latest first bitstream stored in the first buffer, and transmitting the latest first bitstream to the electronic device to decode the latest first bitstream and play the decoded first bitstream, wherein the electronic device is communicatively connected to the camera device.

In an alternative, wherein the camera device further includes a second buffer for temporarily storing the second video bitstream, and the method further includes: storing the second bitstream to the second buffer; if the second buffer is insufficient to store the second bitstream, overwriting the earliest second bitstream stored in the second buffer with the second bitstream to be stored; or removing the earliest stored data from the second buffer, and storing the second bitstream in the second buffer.

In an alternative, the storage unit is the memory card of the camera device, and the encapsulating the second bitstream and storing the second video to the storage unit includes: retrieving the second bitstream from the second buffer when detecting the intrusion target in the monitored area; encapsulating the retrieved second bitstream into the second video; and storing the second video to the memory card.

In an alternative, the method further includes: if the intrusion target is detected in the monitored area starting from a first moment, retrieving the second bitstream within a first duration that is prior to and closest to the first moment from the second buffer, and encapsulating the retrieved second bitstream into the second video; if the intrusion target is detected leaving the monitored area starting from a second moment, retrieving the second bitstream within a second duration after and closest to the second moment from the second buffer, and encapsulating the retrieved second bitstream into the second video.

In an alternative, the method further includes: in response to a request for real-time viewing of the second bitstream sent by an electronic device, acquiring the latest second bitstream from the second buffer, and transmitting the latest second bitstream to the electronic device to decode the latest second bitstream and play the decoded second bitstream, wherein the electronic device is communicatively connected to the camera device.

In an alternative, the storage unit is a hard disk in the network video recorder communicatively connected to the camera device, and the network video recorder further includes a third buffer for temporarily storing the first bitstream; and wherein the encapsulating the first bitstream into a first video and storing the first video to a storage unit includes: acquiring the first bitstream from the first buffer, and storing the first bitstream in the third buffer; if the third buffer is insufficient to store the first bitstream, overwriting the earliest first bitstream stored in the third buffer with the first bitstream to be stored; or removing the earliest stored data from the third buffer, and storing the first bitstream to in the third buffer; and acquiring the first bitstream from the third buffer, encapsulating the first bitstream into the first video, and storing the first video to the hard disk.

In an alternative, the method further includes: in response to a request for real-time viewing of the first bitstream sent by an electronic device, acquiring the latest first bitstream from the third buffer, and transmitting the latest first bitstream to the electronic device to decode the latest first bitstream and play the decoded first bitstream, wherein the electronic device is communicatively connected to the network video recorder.

In an alternative, the storage unit is a hard disk in the network video recorder communicatively connected to the camera device, and the network video recorder further includes a fourth buffer for temporarily storing the second bitstream; wherein the encapsulating the second bitstream into a second video and storing the second video to the storage unit includes: acquiring the second bitstream from the second buffer, and storing the second bitstream in the fourth buffer; if the fourth buffer is insufficient to store the second bitstream, overwriting the earliest second bitstream first from the fourth buffer with the second bitstream to be stored; or removing the earliest stored data first from the fourth buffer, and storing the second bitstream in the fourth buffer; and retrieving the second bitstream from the fourth buffer when detecting the intrusion target in the monitored area; encapsulating the retrieved second bitstream into the second video; and storing the second video to the hard disk.

In an alternative, the method further includes: in response to a request for real-time viewing of the second bitstream sent by an electronic device, acquiring the latest second bitstream from the fourth buffer, and transmitting the latest second bitstream to the electronic device to decode the latest second bitstream and play the decoded second bitstream, wherein the electronic device is communicatively connected to the network video recorder.

According to yet another aspect of the embodiments of the present application, a camera device is included, which includes an image capturing unit, a controller and a video encoding unit. The image capturing unit is configured to acquire an image of a monitored area. The video encoding unit is connected to the image capturing unit, and configured to perform encoding on the image captured by the image capturing unit. The controller is connected to the video encoding unit, and configured to execute a computer program stored in a memory of the controller to: control the video encoding unit to encode the image with a first resolution, a first frame rate and a first bitrate to obtain a first bitstream; control the video encoding unit to perform parallel encoding on the image with a second resolution, a second frame rate and a second bitrate to obtain a second bitstream, wherein the second resolution is greater than the first resolution, the second frame rate is greater than or equal to the first frame rate, and the second bitrate is greater than the first bitrate; encapsulate the first bitstream into a first video and storing the first video to a storage unit; and encapsulate the second bitstream into a second video when detecting an intrusion target in the monitored area, and store the second video to the storage unit.

According to yet another aspect of the embodiments of the present application, a video surveillance system is provided, which includes the camera device as described above and a network video recorder communicatively connected to the camera device.

In the embodiments of the present application, the video encoding unit of the camera device is controlled to encode with two different sets of encoding parameters (resolution, frame rate and bitrate) respectively, and a first video and a second video are obtained after encapsulation, where the clarity and size of the two videos are different, so as to meet different requirements of browsing scenarios. The first video is stored in the storage unit, and the stored first video can be subsequently used for subsequent investigation, and the first video which is fluent and occupies a smaller storage space (i.e., a first requirement) can be obtained by setting a lower first resolution, a higher first frame rate and a lower first bitrate, so that the storage unit can store the first video with a longer duration. The stored first video can be online playback at any time point, with small transmission data amount and smooth picture. Since the main function of the camera device is the monitoring function, it is more important to obtain the video recording when an intrusion target is detected in the monitored area, so that the intrusion target can be accurately identified through the video. In the present application, a fluent and high-definition second bitstream can be obtained by setting a higher second resolution, a higher second frame rate and a higher second bitrate, and the second bitstream obtained by encoding when the intrusion target is detected in the monitored area is encapsulated into a fluent and high-definition (i.e., a second requirement) second video and stored in the storage unit. The stored second video can perform online playback of the alarm event, with high-definition and fluent picture.

Further, for the period in which the presence of the intrusion target in the monitored area is detected, not only the first video obtained from video recording during the period but also the second video obtained from video recording during the period are stored, and the data transmission amount of the first video obtained from video recording during the period is less than that of the second video. If the user selects online playback of the video recording during the period when an intrusion target is detected in the monitored area, and the network condition is poor and cannot play the second video normally, the first video can be selected for playback, thereby avoiding playback delay and lag caused by poor network conditions.

### BRIEF DESCRIPTION OF THE DRAWINGS

The drawings are only for purposes of illustrating the embodiments and are not to be construed as limiting the present application. Moreover, like reference numerals designate like parts throughout the several views. In the drawings:

FIG. 1 is a schematic diagram showing an application scenario according to an embodiment of the present application;

FIG. 2 is a schematic structural diagram showing a camera device according to an embodiment of the present application;

FIG. 3 is a schematic diagram showing another application scenario according to an embodiment of the present application;

FIG. 4 is a schematic structural diagram showing a video surveillance system according to an embodiment of the present application;

FIG. 5 is a flowchart of a method for video data generation and storage according to an embodiment of the present application;

FIG. 6 is a flowchart of a method for video data generation and storage according to another embodiment of the present application;

FIG. 7 is an application schematic diagram according to an embodiment of the present application;

FIG. 8 is a flowchart of a method for video data generation and storage according to another embodiment of the present application;

FIG. 9 is another application schematic diagram according to an embodiment of the present application.

### DETAILED DESCRIPTION

Hereinafter, example embodiments of the present application will be described in more detail referring to the accompanying drawings. While example embodiments of the present application are illustrated in the drawings, it should be understood that the present application may be embodied in various forms and should not be limited to the embodiments set forth herein.

In order to improve the utilization of a storage unit of a camera device, if the frame rate of the video is reduced and the video recording is performed at a lower frame rate to reduce the storage space occupied by the video, when the user performs video playback, there will be poor video smoothness and playback quality, and the user experience will be spoiled. Furthermore, if there is an intrusion target in the monitored area and the video frame rate of the camera device is set too low, it is impossible to completely record all behaviors of the intrusion target in the monitored area through the video recording, thus failing to achieve the monitoring function of the camera device.

To achieve the monitoring function of the camera device while reducing the storage space occupied by video recordings, one possible approach is to record at a lower frame rate when no intrusion target is detected in the monitored area, and switch to a higher frame rate for video recording when an intrusion target is detected in the monitored area. For the videos recorded in this manner, there will still be an issue of poor smoothness in video recordings at low frame rates during video playback. Furthermore, since the frame rate and resolution of video recording are higher when an intrusion target is detected in the monitored area, if the user's network condition is poor during online playback of these videos, playback delay and lag may occur, and the user experience will be spoiled.

In the embodiments of the present application, the problem to be solved is how to achieve the monitoring function of the camera device, reduce the storage space occupied by video recordings from the monitored area for playback at any time, ensure good video smoothness during video online playback, and avoid playback delay and lag caused by poor network conditions.

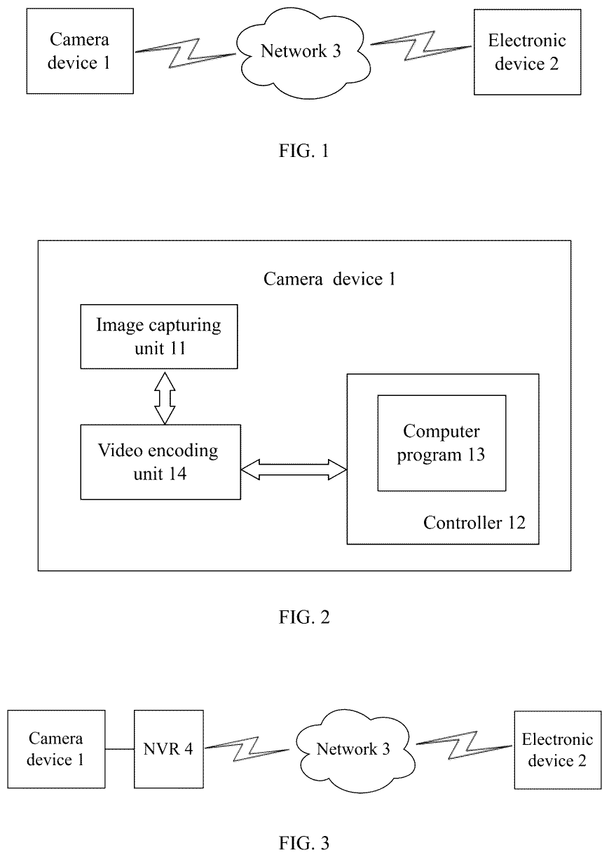

FIG. 1 is a schematic diagram showing an application scenario according to an embodiment of the present application. As shown in FIG. 1, the method for video data generation and storage provided in the present application is applied to a camera device 1. The camera device 1 establishes a communication connection with the electronic device 2 via network 3. The camera device 1 may be a security monitoring apparatus, a networked camera, an IP camera, a networked video recorder, or other video monitoring devices. The electronic device 2 may be a touchscreen phone, a smartphone, a tablet computer, a portable electronic device, or other terminal electronic device with a display screen. The network 3 includes, but is not limited to, one or more of a local region network (LAN), a metropolitan region network (MAN), a wide region network (WAN), a 4G/5G network, a WIFI, a Bluetooth, and any suitable communication networks.

In the embodiment of the present application, the camera device 1 and the electronic device 2 may each include one or more processors, which may be a Central Processing Unit (CPU), or an Application Specific Integrated Circuit (ASIC), or one or more integrated circuits configured to implement the embodiment, and are not limited thereto. One or more processors included in the camera device 1 and the electronic device 2 may be the same type of processor, such as one or more CPUs; it may also be a different type of processor, such as one or more CPUs and one or more ASICs, which is not limited herein.

In the embodiments of the present application, the camera device 1 is installed in areas requiring monitoring (e.g., homes, offices, shopping malls, etc.) to continuously capture video recordings of the monitored area and transmit the captured video recordings to the electronic device 2 via network 3 for user viewing.

FIG. 2 is a schematic structural diagram showing a camera device according to an embodiment of the present application. As shown in FIG. 2, the camera device 1 may include: an image capturing unit 11, a controller 12, and a video encoding unit 14. The image capturing unit 11 connects to the video encoding unit 14, and the video encoding unit 14 connects to the controller 12.

The image capturing unit 11 is configured to capture images of the monitored area. The image capture frequency of the image capturing unit 11 can be set so that the image capturing unit 11 captures images at a specified frequency.

The controller 12 may include a high-speed RAM memory and may also include a non-volatile memory, such as at least one disk storage device. The controller 12 is configured to store a computer program 13 that can be executed by the controller 12 to perform relevant steps in the embodiments of the method for video data generation and storage provided by the present application. In particular, the computer program 13 may include a plurality of computer-executable instructions.

The controller 12 is also configured to control the video encoding unit 14 to perform parallel encoding on an image captured by the image capturing unit 11 with a first set of encoding parameters and a second set of encoding parameters respectively so as to obtain a first bitstream and a second bitstream, where the first set of encoding parameters comprises a first resolution, a first frame rate and a first bitrate, and the second set of encoding parameters comprises a second resolution, a second frame rate and a second bitrate. A bitstream is a video data stream consisting of a series of consecutive compressed data encoded in a specific format (e.g., H.264, HEVC, AAC, etc.). The bitstream itself does not contain file header information or synchronization markers, so it cannot be directly recognized and played by media players, but can be used for real-time viewing of video images.

The controller 12 may be a microcontroller, a Microcontroller Unit (MCU), a Programmable Logic Controller (PLC), a Digital Signal Processor (DSP), a Field-Programmable Gate Array (FPGA), a System on Chip (SoC), etc. The controller 12 may include one or more processors as described above.

The video encoding unit 14 is configured to control the video encoding unit to perform parallel encoding on an image captured by the image capturing unit 11 with a first set of encoding parameters and a second set of encoding parameters so as to obtain a first bitstream and a second bitstream. The video encoding unit 14 may be a microcontroller, MCU, PLC, DSP, FPGA, SoC, or the like. One or more processors as previously described may be included in the video encoding unit 14.

FIG. 3 is a schematic diagram showing an application scenario according to an embodiment of the present application. As shown in FIG. 3, the method for video data generation and storage provided in the present application is applied to a camera device 1. The camera device 1 is communicatively connected to a network video recorder (NVR) 4 via a local area network, and the NVR 4 establishes a communication connection with the electronic device 2 via the network 3. The NVR 4 is used for storing the video recording obtained by the camera device 1 on the monitored area, and for example, the video recording obtained by the camera device 1 can be stored to the hard disk of the NVR 4.

It is worth mentioning that only the communication connection between the NVR 4 and one camera device 1 is illustrated as an example in FIG. 3. In some embodiments, one NVR 4 may be communicatively connected to a plurality of different camera devices 1 to simultaneously process and store video recordings captured by the plurality of camera devices 1. Furthermore, if one NVR 4 is communicatively connected to the plurality of different camera devices 1 simultaneously, the electronic device 2 can view videos recorded by the plurality of different camera devices 1 by establishing a communication connection with the NVR 4 only, without establishing communication connections between the electronic device 2 and each of the plurality of different camera devices 1.

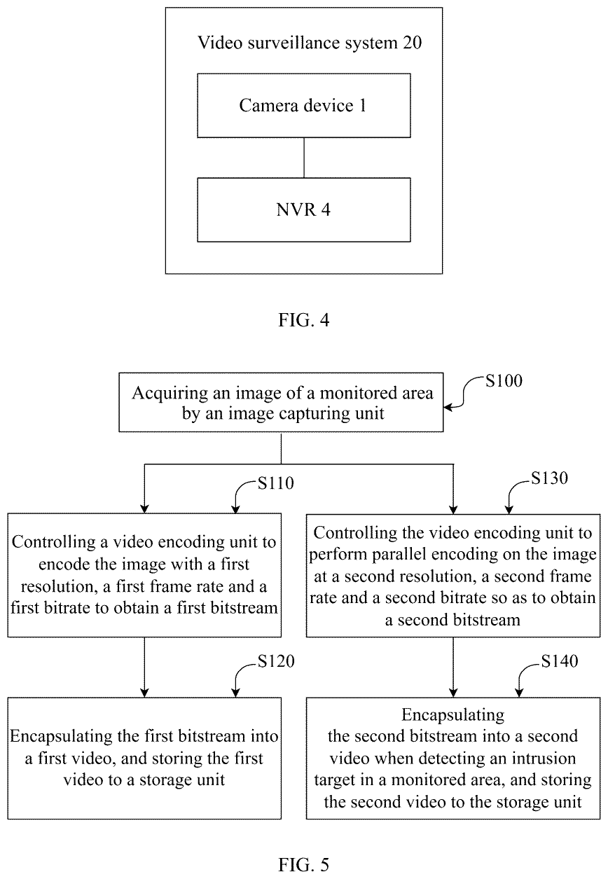

FIG. 4 is a schematic structural diagram showing a video surveillance system according to an embodiment of the present application. As shown in FIG. 4, the video surveillance system 20 includes a camera device 1 and a NVR 4. The camera device 1 is communicatively connected to the NVR 4, and the NVR 4 is used for storing the video obtained by the camera device 1 performing video recording on the monitored area.

Unless otherwise specified, the communication connection in the embodiments of the present application may be a wired communication connection or a wireless communication connection, such as a wireless communication connection established through one or more of LAN, MAN, WAN, 4G/5G network, WIFI, Bluetooth, or any suitable communication networks.

FIG. 5 shows a flowchart of a method for video data generation and storage according to an embodiment of the present application, and the method is applied to the camera device 1. The embodiments of the present application may be applied to the application scenarios shown in FIG. 1 or FIG. 3. In the embodiments of the present application, the method may be performed by the controller 12 in the camera device 1.

In step S100, capturing an image of a monitored area by an image capturing unit 11 of the camera device 1.

In step S110, controlling the video encoding unit 14 to encode the image with a first resolution, a first frame rate and a first bitrate to obtain a first bitstream.

As described above, the camera device 1 may include one or more image capturing units 11. The image capturing unit 11 is configured to acquire images of the monitored area. After the image capturing unit 11 acquires images of the monitored area, the video encoding unit 14 can encode the images acquired by the image capturing unit 11.

The video encoding unit 14 encodes the image at a set of first encoding parameters to obtain the first bitstream according to a specific encoding format (such as H.264, HEVC, AAC, etc.). In the embodiment, the set of first encoding parameters may include a first resolution, a first frame rate and a first bitrate. The first resolution, first frame rate and first bitrate can be set as needed. For example, if the maximum resolution of the camera device 1 is PPIₘₐₓ, the maximum frame rate is Fmax, and the maximum bitrate is Bₘₐₓ, then the first resolution can be set as 0.8*PPIₘₐₓ, 0.6*PPIₘₐₓ or 0.3*PPIₘₐₓ; the first frame rate is set as Fmax, 0.9*Fmax or 0.8*Fmax; and the first bitrate is set as 0.8*Bₘₐₓ, 0.6*Bₘₐₓ or 0.3*Bₘₐₓ.

Since the resolution has a greater impact on the storage space occupied by the video than the frame rate, to balance both the storage space occupied by the video encapsulated from the first bitstream and the smoothness of the video, a lower first resolution can be set to minimize the storage space occupied by the video encapsulated from the first bitstream, while a higher frame rate can be set to maximize the smoothness of the video encapsulated from the first bitstream.

In step S120, encapsulating the first bitstream into a first video, and storing the first video to a storage unit, where a smoothness of the first video and an occupied storage space satisfy a first requirement.

By encapsulating the first bitstream into a first video in a specific format (e.g., MP4, AVI, MKV, etc.) and storing the first video to the storage unit, users can subsequently playback the video recording obtained from the monitored area during historical periods. In the embodiments of the present application, the storage unit may be a memory card (e.g., SD card) in the camera device 1, or a hard disk in the NVR 4.

As described above, the key parameters affecting the smoothness and occupied storage space of the first video are the first resolution, first frame rate and first bitrate. Therefore, to obtain the first video meeting the first requirements, the first resolution, first frame rate and first bitrate can be set as needed. For example, if better smoothness of the first video and smaller occupied storage space are required, the first resolution can be set to a lower resolution (e.g., 0.3*PPIₘₐₓ), the first frame rate to a higher frame rate (e.g., Fmax), and the first bitrate to a lower bitrate (e.g., 0.3*Bₘₐₓ). With the above-mentioned setting, a smooth and low-definition first video can be obtained.

The first resolution, the first frame rate and the first bitrate may be pre-set parameters built in the camera device 1, or may be set by a user's customization. The first requirement is associated with the first resolution, the first frame rate and the first bitrate, for example, the first requirement is that the smoothness of the first video is better and the occupied storage space is smaller, and accordingly, a lower first resolution, a higher first frame rate and a lower first bitrate can be set. If the first resolution, the first frame rate and the first bitrate are pre-set parameters built in the camera device 1, the first requirement is a requirement met by the video obtained after encoding and encapsulating according to the pre-set first resolution, the first frame rate and the first bitrate. If the first resolution, the first frame rate and the first bitrate are custom-set by a user, the user can custom-set the first resolution, the first frame rate and the first bitrate according to the requirements (i.e., the first requirements) of the first video, and the user can also directly set the first requirements; and the camera device 1 sets the first resolution, the first frame rate and the first bitrate which meet the first requirements according to the first requirements set by the user. For example, a mapping table of a first requirement and encoding parameters may be built in the camera device 1, and the mapping table records a corresponding relationship between video smoothness and frame rate, and a corresponding relationship between storage space occupied by a video and resolution and bitrate, so as to determine the first resolution, the first frame rate and the first bitrate by looking up the table based on the first requirement customized by a user.

In step S130, controlling the video encoding unit 14 to perform parallel encoding on an image captured by the image capturing unit 11 at a second resolution, a second frame rate and a second bitrate so as to obtain a second bitstream.

By performing a parallel encoding operation on the images captured by the image capturing unit 11, two different bitstreams are obtained. In order to allow the video encoding unit 14 to perform the parallel encoding operation, steps S110 and S130 may be implemented using the same video encoding unit 14, or steps S110 and S130 may be implemented using two video encoding units 14. If seps S110 and S130 are implemented with the same video encoding unit, S110 may be implemented in one channel of the video encoding unit 14, and steps S130 may be implemented in the other channel. If steps S110 and S130 are implemented with two video encoding units 14, step S110 may be implemented in one video encoding unit 14, and step S130 may be implemented in the other video encoding unit 14. The second resolution is greater than the first resolution, the second frame rate is greater than or equal to the first frame rate, and the second bitrate is greater than the first bitrate.

In step S140, encapsulating the second bitstream into a second video when detecting an intrusion target in a monitored area, and storing the second video to the storage unit, where clarity and smoothness of the second video satisfy a second requirement.

In this step, the second video is encapsulated and stored in the storage unit in an implementation manner similar to that of step S120, and reference can be made to step S120. In order to obtain the second video satisfying the second requirement, the set of second encoding parameters including the second resolution, the second frame rate, and the second bitrate may be set as needed. For example, if better smoothness and clarity of the second video is desired, the second resolution may be set to a higher resolution, such as PPIₘₐₓ, the second frame rate may be set to a higher frame rate, such as Fmax, and the second bitrate may be set to a higher bitrate, such as Bₘₐₓ. With the above-mentioned setting, a smooth and high-definition second video can be obtained.

In the embodiments of the present application, the video encoding unit 14 can be controlled to execute steps S110 and S130 at the same time, and in order to reduce the storage space occupied by the video stored in the storage unit and improve the utilization rate of the storage unit, in step S140, only the second bitstream encoded when the presence of the intrusion target in the monitored area is detected is encapsulated into the second video, and the second bitstream encoded when the presence of the intrusion target in the monitored area is not detected is not encapsulated into the video. By encapsulating the second bitstream encoded into the second video when the intrusion target is detected in the monitored area, compared with encapsulating all second bitstreams into the second video, the storage space occupied by the finally obtained second video can be reduced.

It can be understood that steps S110 and S130 encode the images captured by the image capturing unit 11 in real time, and encode the images captured by the image capturing unit 11 at the same time with different encoding parameters, i.e., both the first video and the second video are stored for the time period when the presence of the intrusion target in the monitored area is detected.

Similarly to the set of first encoding parameters and the set of second encoding parameters may be pre-set parameters built into the camera device 1, or may be set by a user's customization. The second requirement is associated with the second resolution, the second frame rate and the second bitrate, for example, the second requirement is that the smoothness and the clarity of the second video are all better, and accordingly, a higher second resolution, a higher second frame rate and a higher second bitrate can be set. If the second resolution, the second frame rate, and the second bitrate are pre-set parameters built in the camera device 1, the second requirement is a requirement met by the video obtained after encoding and encapsulating according to the pre-set second resolution, the second frame rate, and the second bitrate. If the second resolution, the second frame rate and the second bitrate are custom-set by a user, the user can custom-set the second resolution, the second frame rate and the second bitrate according to the second requirement of the second video, and the user can also directly set the second requirement; and the camera device 1 sets the second resolution, the second frame rate and the second bitrate which meet the second requirement according to the second requirement set by the user. For example, the above-mentioned mapping table can also serve as a mapping table of the second requirement and the encoding parameters at the same time, and the mapping table also records the corresponding relationship between the video clarity and the resolution, so as to determine the second resolution, the second frame rate and the second bitrate by looking up the table based on the second requirement customized by the user.

In the embodiments of the present application, the video encoding unit 14 of the camera device 1 is controlled to encode with two different sets of encoding parameters (resolution, frame rate and bitrate) respectively, and a first video and a second video are obtained after encapsulation, where the clarity and size of the two videos are different, so as to meet different requirements of browsing scenarios. The first video is stored in the storage unit, and the stored first video can be subsequently used for subsequent investigation, and the first video which is fluent and occupies a smaller storage space (i.e., a first requirement) can be obtained by setting a lower first resolution, a higher first frame rate and a lower first bitrate, so that the storage unit can store the first video with a longer duration. The stored first video can be online playback at any time point, with small transmission data amount and smooth picture.

Since the main function of the camera device 1 is the monitoring function, it is more important to obtain the video recording when an intrusion target (i.e., an alarm event) is detected in the monitored area, so that the intrusion target can be accurately identified through the video. In the embodiments of the present application, a fluent and high-definition second bitstream can be obtained by setting a higher second resolution, a higher second frame rate and a higher second bitrate, and the second bitstream obtained by encoding when the intrusion target is detected in the monitored area is encapsulated into a fluent and high-definition (i.e., a second requirement) second video and stored in the storage unit. The second video can perform online playback of the alarm event, with high-definition and fluent picture.

Further, for the period in which the presence of the intrusion target in the monitored area is detected, not only the first video obtained from video recording during the period but also the second video obtained from video recording during the period are stored, and the data transmission amount of the first video obtained from video recording during the period is less than that of the second video. If the user selects online playback of the video recording during the period when an intrusion target is detected in the monitored area, and the user's network condition is poor and cannot play the second video normally, the first video can be selected for playback, thereby avoiding playback delay caused by poor network condition.

A user may obtain a first video that meets a first requirement by setting a first resolution, a first frame rate, and a first bitrate. Since the first video meets the first requirement, its smoothness and flow both meet the user's requirements, therefore when the user selects online playback of the first video, the playback quality can meet the expected requirements, so that the user experience will not be spoiled. Similarly, a user may obtain a second video that meets a second requirement by setting a second resolution, a second frame rate, and a second bitrate. Since the second video meets the second requirement, its smoothness and flow both meet the user's requirements, therefore, when the user selects online playback of the second video, the playback quality can meet the expected requirements, so the user experience will not be spoiled.

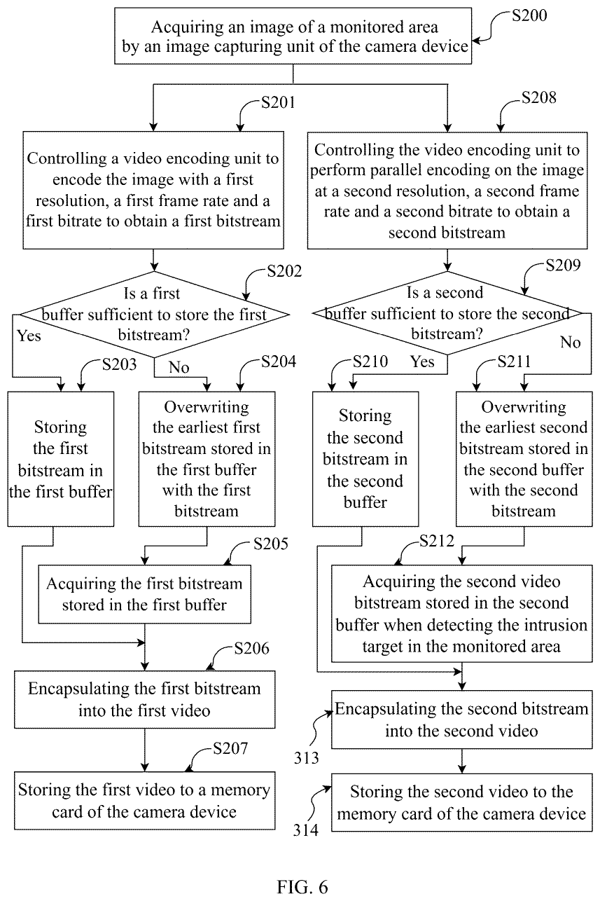

FIG. 6 shows a flowchart of a method for video data generation and storage according to another embodiment of the present application, and the method is performed by the camera device 1. The embodiments of the present application can be applied to the application scenario shown in FIG. 1, a memory card (e.g., an SD card) in the camera device 1 is used as a storage unit to store the encapsulated first video and second video. In the embodiments of the present application, the camera device 1 further includes a first buffer and a second buffer for temporarily storing bitstreams. The first buffer and second buffer can be located in the memory of the camera device, such as random-access memory (RAM), where the first buffer and second buffer can be respectively allocated for the first bitstream and second bitstream.

In step S200, capturing an image of a monitored area by the image capturing unit 11 of the camera device 1.

In step S201, controlling the video encoding unit 14 to encode the image with a first resolution, a first frame rate and a first bitrate to obtain a first bitstream.

Step S201 is similar to step S110, and therefore, the principle and specific implementation of step S201 can be referred to step S110, which will not be described in detail herein.

In step S202, determining whether the remaining storage space of the first buffer is sufficient to store the first bitstream to be stored. If so, the process proceeds to step S203; if not, proceeds to step S204.

The main function of a buffer in the camera device 1 is to store bitstream data to ensure smooth processing and transmission of video bitstream data. In the embodiments of the present application, the first bitstream encoded by the video encoding unit 14 is all stored in the first buffer. Since the storage space of the first buffer is limited, generally only the first bitstream encoded within a certain time period can be stored in the first buffer. The first bitstream to be temporarily stored refers to a bitstream obtained by encoding in real time by the video encoding unit 14 and needing to be stored in the buffer.

In step S203, storing the first bitstream to be stored in the first buffer.

If the remaining storage space of the first buffer is sufficient to store the first bitstream, the first bitstream is directly stored in the first buffer in this step.

In step S204, overwriting the earliest first bitstream stored in the first buffer with the first bitstream to be stored, so that the data stored in the first buffer is the first bitstream encoded within the time period closest to the current moment.

Since the first buffer can only store a certain amount of data, when the video encoding unit 14 generates new first video bitstream data, it overwrites the earliest stored first video bitstream data in the first buffer with the new first video bitstream data, so that the stored data in the first buffer is the first video bitstream encoded within the time period closest to the current moment.

For example, if the first buffer stores the first bitstream encoded from the 1^{st} to 11^{th} seconds in the past closest to the current moment, and the storage space of the first buffer is fully occupied, then for the new first bitstream from the 11^{th} to 12^{th} seconds, if its occupied storage space is the same as that of the earliest stored first bitstream encoded from the 1^{st} to 2^{nd} seconds in the first buffer, then in S204, the first video bitstream encoded from the 11^{th} to 12^{th} seconds overwrites the first video bitstream encoded from the 1^{st} to 2^{nd} seconds stored in the first buffer, so that the data stored in the first buffer is the first video bitstream encoded from the 2^{nd} to 12^{th} seconds. It is worth mentioning that in some embodiments, step S204 may also include: the earliest stored data are removed from the first buffer and the first video bitstream is stored in the first buffer, so that the data stored in the first buffer is the first video bitstream encoded within the time period closest to the current moment. For example, if the current first buffer stores the first video bitstream encoded from the 1^{st} to 11^{th} seconds in the past closest to the current moment, and the storage space of the first buffer is fully occupied, the first video bitstream encoded from the 1^{st} to 2^{nd} seconds is removed from the first buffer, and the first video bitstream encoded from the 11^{th} to 12^{th} seconds is stored in the first buffer.

In step S205, acquiring the first bitstream stored in the first buffer.

In this step, acquiring the first stream data is mainly for subsequently encapsulating the first bitstream into a video.

In step S206, encapsulating the first bitstream into the first video.

Step S206 is similar to step S120, and therefore, reference can be made to step S120 for the principle and specific implementation of step S206, which will not be described in detail herein.

In step S207, storing the first video to the memory card in the camera device 1.

In step S208, controlling the video encoding unit 14 to perform parallel encoding on an image captured by the image capturing unit 11 at a second resolution, a second frame rate and a second bitrate so as to obtain a second video bitstream.

The second resolution is greater than the first resolution, the second frame rate is greater than or equal to the first frame rate, and the second bitrate is greater than the first bitrate. Step S208 is similar to step S130, and therefore, reference can be made to step S130 for the principle and specific implementation of step S208, which will not be described in detail herein.

In step S209, determining whether the remaining storage space of the second buffer is sufficient to store the second bitstream to be stored. If so, the process proceeds to step S210; if not, proceeds to step S211.

In step S210, storing the first video bitstream in the first buffer.

In step S211, overwriting the earliest stored second video bitstream currently in the second buffer with the second video bitstream to be stored, so that the data stored in the second buffer is the second video bitstream encoded within the time period closest to the current moment.

It is worth mentioning that in some embodiments, step S210 may also include: the earliest stored data are removed from the second buffer and the second video bitstream is stored in the second buffer, so that the data stored in the second buffer is the second video bitstream encoded within the time period closest to the current moment.

Steps S209 to S211 are similar to steps S202 to S204, and therefore, reference can be made to steps S202 to S204 for the principle and specific implementation of steps S209 to S211, which will not be described in detail herein.

In step S212, acquiring the second video bitstream stored in the second buffer when detecting the intrusion target in the monitored area.

As mentioned earlier, the video encoding unit can be controlled to execute steps S201 and S208 simultaneously in real time. To reduce the storage space occupied by the second video obtained by encapsulating the second video bitstream, in step S212, only the second video bitstream stored in the second buffer and encoded when an intrusion target is detected in the monitored area is acquired, without acquiring the second video bitstream stored in the second buffer and encoded when no intrusion target is detected in the monitored area.

In step S213, encapsulating the second video bitstream stored in the second buffer into the second video when detecting the intrusion target in the monitored area.

Step S213 is similar to step S140, and therefore, reference can be made to step S140 for the principle and specific implementation of step S213, which will not be described in detail herein.

In step S214, storing the second video to the memory card in the camera device 1.

Step S214 is similar to step S207, and therefore, reference can be made to step S207 for the principle and specific implementation of step S214, which will not be described in detail herein.

In the embodiments of the present application, since the buffer can play a buffering role, by storing the first video bitstream and second video bitstream encoded by the video encoding unit 14 into the first buffer and second buffer respectively, data loss caused by failure to timely encapsulate the first video bitstream and second video bitstream into the first video and second video is avoided, ensuring smooth processing and transmission of video bitstream data.

Furthermore, since the storage unit is the memory card of the camera device 1, if the memory card is full, new video data to be stored will overwrite the originally stored video data, and the lifespan of the memory card is related to the number of times the memory card is fully written. In the embodiments of the present application, by performing parallel encoding on images captured by the image capturing unit 11 with a first set of encoding parameters and a second set of encoding parameters, the first video bitstream and the second video bitstream are obtained. The first video bitstream and the second video bitstream are encapsulated into the first video and the second video respectively and stored in the memory card. The storage space occupied by the first video within the same duration is less than that occupied by the second video. Compared with a single method of encoding images captured by the image capturing unit 11 only with the second resolution, the second frame rate and the second bitrate and encapsulating them into the second video, this method can reduce the storage space occupied by videos, thereby improving the lifespan of the memory card, while the second video can also provide high-definition and smooth playback of alarm events.

To facilitate users' real-time viewing of monitoring videos, the embodiments of the present application further include the following steps in the method for video data generation and storage:

In step a01, in response to a request from the electronic device 2 for real-time viewing of the first video bitstream, acquiring the latest stored first video bitstream in the first buffer.

In step a02, transmitting the latest stored first video bitstream in the first buffer to the electronic device 2, so that after receiving the first video bitstream, the electronic device 2 decodes and plays the decoded first video bitstream.

In steps a01 to a02, to improve the user experience, users can view the video recording obtained by the camera device 1 through the electronic device 2 connected to the camera device 1, so as to monitor the monitored area in real time, such as detecting whether there is an intrusion target in the monitored area. If the user selects real-time viewing of the first video bitstream, the latest stored first video bitstream in the first buffer is obtained and transmitted to the electronic device 2, so that the electronic device 2 receives the latest stored first video bitstream from the first buffer, decodes the received first video bitstream to obtain image data suitable for display on the display screen of the electronic device 2, and displays the decoded image data. Since the user selects real-time viewing of the first video bitstream to understand the security status of the monitored area at the current moment in real time, and the data stored in the first buffer is the first video bitstream encoded within a period closest to the current moment, with the image capturing unit 11 performing real-time image capture of the monitored area, the video encoding unit 14 encoding the images acquired by the image capturing unit 11 into the first video bitstream in real time and storing the first video bitstream to the first buffer in real time, in step a01, the latest stored first video bitstream is acquired from the first buffer and transmitted to the electronic device 2 to enable the user to understand the security status of the monitored area at the current moment through the camera device 1 in real time.

Furthermore, since the amount of data obtained by decoding the first video bitstream is large, if the camera device 1 transmits the first video bitstream stored in the first buffer to the electronic device 2 after decoding, it would increase the amount of data transmitted from the camera device 1 to the electronic device 2, reducing transmission efficiency. In step a02, by directly transmitting the first video bitstream with a small amount of data to the electronic device 2, the electronic device 2 decodes the received first video bitstream and then plays the decoded first video bitstream, instead of transmitting the decoded first video bitstream to the electronic device 2, the amount of data transmitted to the electronic device 2 by the camera device 1 is reduced, and the transmission efficiency is improved.

In step a03, in response to a request from the electronic device 2 for real-time viewing of the second video bitstream, acquiring the latest stored second video bitstream in the second buffer.

In step a04, transmitting the latest stored second video bitstream in the second buffer to the electronic device 2, so that after receiving the latest stored second video bitstream in the first buffer, the electronic device 2 decodes and plays the decoded second video.

Steps a03 and a04 are similar to steps a01 and a02, and therefore, reference can be made to steps a01 and a02 for the principles and specific implementation of steps a03 and a04, which will not be described in detail herein.

Real-time viewing of the first video bitstream and the second video bitstream have different requirements for the network, but real-time viewing of the second video bitstream has a higher requirement for the network. If only the single mode of encoding images captured by the image capturing unit 11 with the second resolution, the second frame rate and the second bitrate to obtain the second video bitstream is set, when users want to understand the security of the current monitored area, they can only choose real-time viewing of the second video bitstream. However, if the user's network condition is poor, playback delay and lag may occur, and the user experience will be spoiled.

In the embodiments of the present application, when users want to know the security of the current monitored area, they can choose to browse the first video bitstream or the second video bitstream in real-time viewing according to the actual network condition. If the user's network condition is good, the second video bitstream can be selected for real-time viewing; if the network condition is poor, the first video bitstream can be selected for real-time viewing. By setting two buffers to store the first video bitstream and the second video bitstream respectively, different requirements of users can be met, the user experience is improved, and the application scope of the present application is also expanded.

To improve the monitoring effect on the monitored area, in the embodiments of the present application, the method for video data generation and storage further includes the following steps:

Step b01, if the intrusion target is detected in the monitored area starting from a first moment, acquiring the second video bitstream stored in the second buffer and obtained by encoding within a first duration that is prior to and closest to the first moment, encapsulating the second video bitstream into the second video, and store the second video to the storage unit.

If the monitored area is large and the detection capability of the camera device 1 is limited, when the camera device 1 detects whether there is an intrusion target in the monitored area, only when the intrusion target enters the central area of the monitored area can the camera device 1 detect the intrusion target. The activities of the intrusion target in the edge area of the monitored area and the activity process of the intrusion target entering the central area from the edge area cannot be detected by the camera device 1 in time.

However, to investigate the entire activity process of the intrusion target in the monitored area using clearer video as much as possible, in this step, by acquiring the second video bitstream stored in the second buffer and encoded within the first duration before and closest to the first moment, and encapsulating it into a second video, subsequently, the activity process of the intrusion target in the edge area of the monitored area and the activity process of the intrusion target entering the central area from the edge area can be investigated through this second video. The first duration can be set as needed, such as 10 s, 15 s, etc.

Step b02, if the intrusion target is detected leaving the monitored area starting from a second moment, acquiring the second video bitstream stored in the second buffer and obtained by encoding within a second duration after and closest to the second moment, encapsulate the second video bitstream into the second video, and store the second video to the storage unit.

Step b02 is similar to step b01, by acquiring the second video bitstream stored in the second buffer and encoded within the second duration after and closest to the second moment, and encapsulating it into a second video, the activity process of the intrusion target from the central area to the edge area of the monitored area and the activity process of the intrusion target in the edge area can be subsequently investigated through this second video. The second duration can be set as needed, such as 10 s, 15 s, etc.

For example, the intrusion target is at the edge area of the monitored area at the 1^{st} second, and during the period from the 1^{st} to the 10th seconds, it moves from the edge area to the central area of the monitored area. If the camera device 1 detects the intrusion target only at the 10^{th} second, it starts encapsulating the second video bitstream into the second video. However, if the second video at the 1^{st} to the 10^{th} seconds is not stored, the activity process of the intrusion target in the monitored area during the 1^{st} to the 10^{th} seconds can only be investigated subsequently through the first video. Since the resolution of the first video is lower than that of the second video, i.e., the clarity of the first video is poorer, it may be impossible to effectively identify the activity process of the intrusion target in the monitored area during the 1^{st} to the 10^{th} seconds through the first video.

Similarly, for example, if the intrusion target moves from the central area to the edge area of the monitored area during the 30^{th} to the 40th seconds and finally leaves the monitored area, and if the second video at the 30^{th} to the 40^{th} seconds is not stored, the activity process of the intrusion target in the monitored area during the 30^{th} to the 40^{th} seconds can only be investigated subsequently through the first video, it may be impossible to effectively identify the activity process of the intrusion target in the monitored area during the 30^{th} to the 40^{th} seconds through the first video.

For the above, in the embodiments of the present application, if the intrusion target is detected in the monitored area starting from a first moment and it is detected that the intrusion target leaves the monitored area starting from a second moment, the second video bitstream encoded within the first duration before and closest to the first moment and the second video bitstream encoded within the second duration after and closest to the second moment are encapsulated into a second video and stored in the storage unit. Subsequently, the entire activity process of the intrusion target in the monitored area can be effectively and accurately identified through the second video with better clarity.

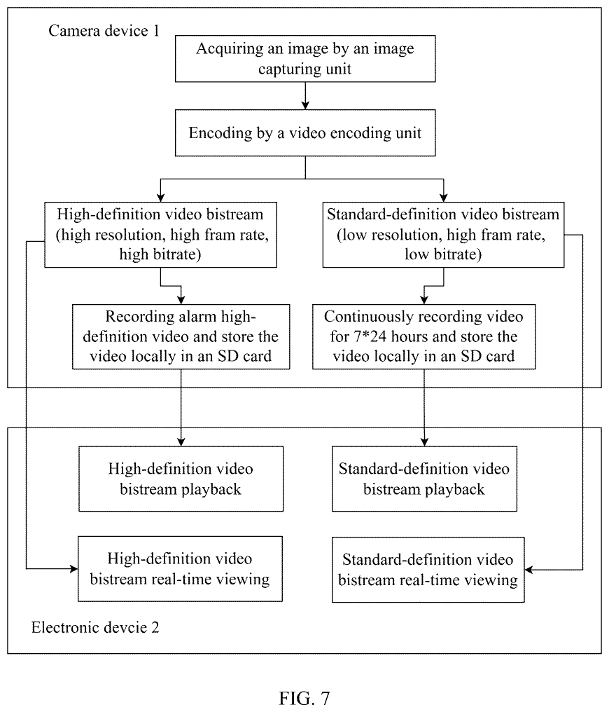

FIG. 7 is an application schematic diagram according to an embodiment of the present application. As shown in FIG. 7, the image capturing unit 11 of the camera device 1 acquires an image. The video encoding unit 14 encodes the images captured by the image capturing unit 11 simultaneously to generate two video bitstreams: a high-definition video bitstream (i.e., the second video bitstream) and a standard-definition video bitstream (i.e., the first video bitstream). The high-definition video bitstream is a video bitstream with high resolution, high frame rate and high bitrate, providing clear and fluent picture quality; a standard-definition video bitstream is a video bitstream with low resolution, high frame rate and low bitrate, which has fluent picture quality but lower clarity than the high-definition video bitstream. The camera device 1 continuously saves the standard-definition video bitstream to the SD card for 7*24 hours, so as to realize the local continuous video recording for 7*24 hours. When an alarm trigger occurs, the n-second high-definition video bitstream (i.e., pre-recorded data) in the buffer before the alarm trigger, the high-definition video bitstream during the alarm process, and the m-second high-definition video bitstream after the alarm ends are all encapsulated into a video and saved to the SD card to achieve alarm high-definition video recording. When the electronic device 2 accesses the camera device 1 via an application to perform video playback: if the network bandwidth of the electronic device 2 is low, or when video playback at any time point of the 7*24 hours is required, a standard-definition video bitstream video recording file from the SD card can be selected for playback; if the network bandwidth of the electronic device 2 is sufficient, or only alarm event recordings need to be reviewed, the high-definition video bitstream alarm recording file in the SD card can be selected for playback, allowing better observation of every detail in the alarm event picture through high-definition quality.

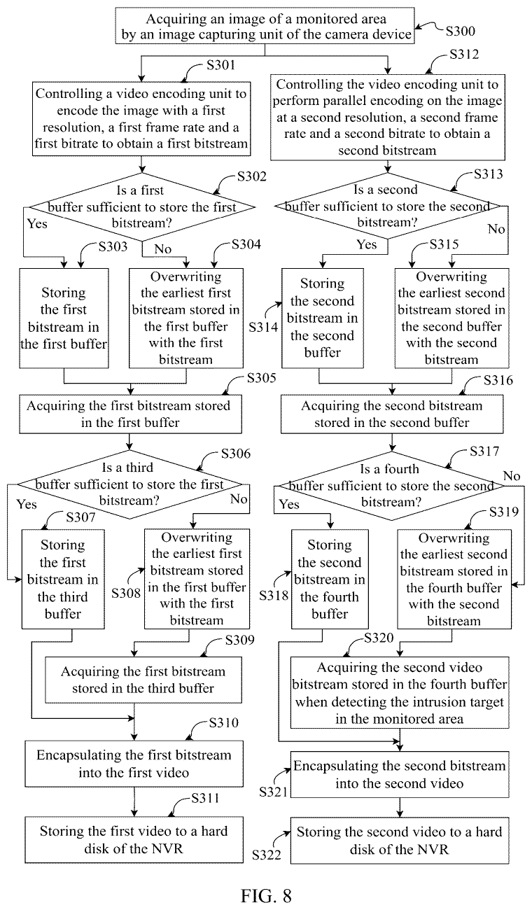

FIG. 8 shows a flowchart of the method for video data generation and storage according to another embodiment of the present application, which is executed by the video surveillance system 20 shown in FIG. 4, specifically by the camera device 1 and the network video recorder 4 in the video surveillance system 20. The application scenario of the embodiments of the present application is the application scenario shown in FIG. 3, the storage unit is a hard disk in the NVR 4, steps S301 to S304 and S312 to S315 are executed by the camera device 1, and steps S305 to S311 and S316 to S322 are executed by the NVR 4.

In step S300, capturing an image of a monitored area by the image capturing unit 11 of the camera device 1.

In step S301, controlling the video encoding unit 14 to encode an image captured by the image capturing unit with a first resolution, a first frame rate and a first bitrate to obtain a first video bitstream.

In step S302, determining whether the remaining storage space of the first buffer is sufficient to store the first video bitstream to be stored. If so, the process proceeds to S303; if not, proceeds to S304.

In step S303, store the first video bitstream in the first buffer.

In step S304, overwriting the earliest stored first video bitstream in the first buffer with the first video bitstream, so that the data stored in the first buffer is the first video bitstream encoded within the time period closest to the current moment.

It is worth mentioning that in some embodiments, step S304 may also include: the earliest stored data are removed from the first buffer, and the first video bitstream to be stored is stored in the first buffer, so that the data stored in the first buffer is the first video bitstream encoded within the time period closest to the current moment.

Steps S301 to S304 are similar to steps S201 to S204, and therefore, reference can be made to steps S201 to S204 for the principle and specific implementation of steps S301 to S304, which will not be described in detail herein.

In step S305, acquiring the first video bitstream stored in the first buffer.

The first video bitstream is acquired by the network video recorder 4 from the first buffer of the camera device 1.

In step S306, determining whether the remaining storage space of the third buffer is sufficient to store the first video bitstream to be stored. If so, the process proceeds to S307; if not, the process proceeds to S308.

The third buffer is a buffer in the network video recorder 4, which is similar to the first buffer and the second buffer.

In step S307, storing the first video bitstream in the third buffer.

In step S308, overwriting the earliest first video bitstream stored in the third buffer with the first video bitstream, so that the data stored in the third buffer is the first video bitstream encoded within the time period closest to the current moment.

It is worth mentioning that in some embodiments, step S308 may also include: the earliest stored data are removed from the third buffer, and the first video bitstream is stored in the third buffer, so that the data stored in the third buffer is the first video bitstream encoded within the time period closest to the current moment.

In step S309, acquiring the first video bitstream stored in the third buffer.

In step S310, encapsulating the first video bitstream into the first video.

In step S311, storing the first video to the hard disk in the network video recorder 4.

Steps S307 to S311 are similar to steps S203 to S207, and therefore, reference can be made to steps S203 to S207 for the principle and specific implementation of steps S307 to S311, which will not be described in detail herein.

In step S312, controlling the video encoding unit 14 to perform parallel encoding on the image captured by the image capturing unit 11 with a second resolution, a second frame rate and a second bitrate to obtain a second video bitstream, where the second resolution is greater than the first resolution, the second frame rate is greater than or equal to the first frame rate, and the second bitrate is greater than the first bitrate.

In step S313, determining whether the remaining storage space of the second buffer is sufficient to store the second video bitstream to be stored. If so, the process proceeds to S314; if not, proceeds to S315.

In step S314, storing the second video bitstream in the second buffer.

In step S315, overwriting the earliest second video bitstream stored in the second buffer with the second bitstream to be stored in the second buffer, so that the data stored in the second buffer is the second video bitstream encoded within the time period closest to the current moment.

It is worth mentioning that in some embodiments, S315 may also include: the earliest stored data are removed from the second buffer, and the second video bitstream to be stored is stored in the second buffer, so that the data stored in the second buffer is the second video bitstream encoded within the time period closest to the current moment.

Steps S312 to S315 are similar to steps S208 to S211, and therefore, reference can be made to steps S208 to S211 for the principle and specific implementation of steps S312 to S315, which will not be described in detail herein.

In step S316, acquiring the second video bitstream from the second buffer.

The second video bitstream is acquired by the network video recorder 4 from the second buffer of the camera device 1.

In step S317, determining whether the remaining storage space of the fourth buffer is sufficient to store the second video bitstream to be stored. If so, the process proceeds to S318; if not, proceeds to S319.

The fourth buffer is a buffer in the network video recorder 4, which is similar to the first buffer and the second buffer.

In step S318, storing the second video bitstream in the fourth buffer.

In step S319, overwriting the earliest second video bitstream stored in the fourth buffer with the second video bitstream, so that the data stored in the fourth buffer is the second video bitstream encoded within the time period closest to the current moment.

It is worth mentioning that in some embodiments, step S319 may also include: the earliest stored data are removed from the fourth buffer and the fourth video bitstream is stored in the fourth buffer, so that the data stored in the fourth buffer is the fourth bitstream encoded within the time period closest to the current moment.

In step S320, acquiring the second video bitstream from the fourth buffer when detecting the intrusion target in the monitored area.

In step S321, encapsulating the acquired fourth video bitstream into the second video when detecting the intrusion target in the monitored area.

In step S322, storing the first video to the hard disk in the network video recorder 4.

Steps S318 to S322 are similar to steps S210 to S214, and therefore, reference can be made to steps S210 to S214 for the principles and specific implementation of steps S318 to S322, which will not be described in detail herein.

Since the storage capacity of the hard disk of the network video recorder 4 is larger than that of the memory card of the camera device 1, in the embodiments of the present application, by using the hard disk of the network video recorder 4 as the storage unit for storing the first video and the second video, it is possible to store videos for a longer duration, satisfying the user's requirement for video playback at earlier time points. Since one network video recorder 4 can be communicatively connected to a plurality of camera devices 1 simultaneously, in the embodiments of the present application, by using the hard disk in the network video recorder 4 as the storage unit for storing the first video and the second video, one network video recorder 4 can simultaneously store videos recorded by the plurality of camera devices 1. Thus, to view videos recorded by the plurality of camera devices 1, the user does not need to establish communication connections between the electronic device 2 and each of the plurality of camera devices 1 separately, but only needs to establish a communication connection between the electronic device 2 and the network video recorder 4, thereby conveniently viewing videos recorded by the plurality of camera devices 1.

To facilitate users to perform real-time viewing on the monitoring video, on the basis of the embodiment shown in FIG. 8, in the embodiments of the present application, the method for video data generation and storage further includes the following steps:

In step a01, in response to a request from the electronic device 2 for real-time viewing of the first video bitstream, acquiring the latest first video bitstream from the third buffer.

In step c02, transmitting the latest first bitstream to the electronic device 2, so that after receiving the latest first video bitstream, the electronic device 2 decodes and plays the decoded first video.

In step c03, in response to a request from the electronic device 2 for real-time viewing of the second video bitstream, acquiring the latest second video bitstream from the fourth buffer of the electronic device 2.

In step c04, transmitting the latest second video bitstream to the electronic device 2, so that after receiving the latest second video bitstream, the electronic device 2 decodes and plays the decoded second video.

Steps c01 to c04 are similar to steps a01 to a04, and therefore, reference can be made to steps a01 to a04 for the principles and specific implementation of steps c01 to c04, which will not be described in detail herein.

Since acquiring the first bitstream from the first buffer in the camera device 1 and storing it in the third buffer in the NVR 4 requires bandwidth, while acquiring the stored first video bitstream from the third buffer in the NVR 4 and encapsulating it into the first video for storage to the hard disk of the NVR 4 is performed locally in the NVR 4 and does not require bandwidth. Therefore, if in response to a request from the electronic device 2 for real-time viewing of the first video bitstream, the latest stored first video bitstream in the first buffer is acquired and transmitted to the electronic device 2, occupation of additional bandwidth is required, which is equivalent to performing two data transmissions: one to the third buffer and the other to the electronic device 2, which would reduce the efficiency of transmitting the first video bitstream from the first buffer to the third buffer.

For the above, in the embodiments of the present application, in response to a request for real-time viewing of the first video bitstream sent by the electronic device 2, by acquiring the latest stored first video bitstream in the third buffer and transmitting it to the electronic device 2, there is no need to occupy additional bandwidth to transmit the first video bitstream from the first buffer to the electronic device 2, so that the efficiency of transmitting the first video bitstream from the first buffer to the third buffer is not reduced, and thus adverse situations such as jitter occurring in data transmission due to poor network conditions do not occur.

It is worth mentioning that, the technical effect achieved by acquiring the latest stored second video bitstream in the fourth buffer and transmitting it to the electronic device 2 in response to a request for real-time viewing of the second video bitstream sent by the electronic device 2 is the same as the technical effect achieved by acquiring the latest stored first video bitstream in the third buffer and transmitting it to the electronic device 2 in response to a request for real-time viewing of the first video bitstream sent by the electronic device 2, which will not be described in detail herein.

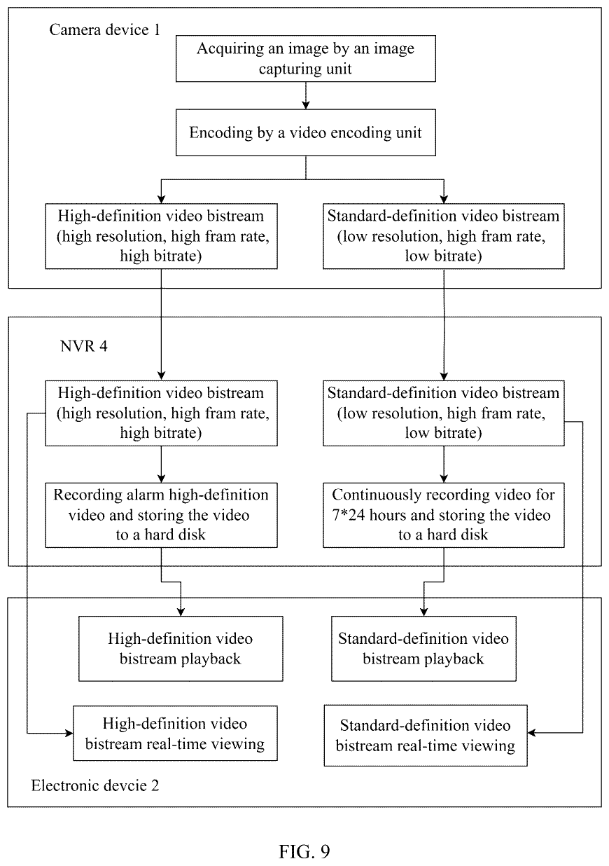

FIG. 9 is another application schematic diagram according to an embodiment of the present application. As shown in FIG. 9, the image capturing unit 11 of the camera device 1 acquires an image of the monitored area. The video encoding unit 14 encodes the images captured by the image capturing unit 11 simultaneously to generate two video bitstreams: a high-definition video bitstream (i.e., the second video bitstream) and a standard-definition video bitstream (i.e., the first video bitstream). The high-definition video bitstream is a video bitstream with high resolution, high frame rate and high bitrate, providing clear and fluent picture quality; a standard-definition video bitstream is a video bitstream with low resolution, high frame rate and low bitrate, which has fluent picture quality but lower clarity than the high-definition video bitstream. The network video recorder 4 is in communication connection with the camera device 1; the camera device 1 continuously records video for 7*24 hours; and the NVR 4 continuously acquires the standard-definition video bitstream in the buffer of the camera device 1 for 7*24 hours, and completely saves it to the hard disk, so as to realize continuous video recording on the hard disk for 7*24 hours. When an alarm trigger occurs, the network video recorder 4 acquires the n-second high-definition video bitstream (i.e., pre-recorded data) in the buffer before the alarm trigger, the high-definition video bitstream during the alarm process, and the m-second high-definition video bitstream after the alarm ends and encapsulate them all into a video and saved to the hard disk to achieve alarm high-definition video recording. When the electronic device 2 accesses the network video recorder 4 via an application to perform video playback: if the network bandwidth of the electronic device 2 is low, or when video playback at any time point of the 7*24 hours is required, a standard-definition video bitstream video recording file from the hard disk can be selected for playback; if the network bandwidth of the electronic device 2 is sufficient, or only alarm event recordings need to be reviewed, the high-definition video bitstream alarm recording file in the hard disk can be selected for playback, allowing better observation of every detail in the alarm event picture through high-definition quality.

The embodiments of the present application provide a computer-readable storage medium that stores a computer program that, when executed by a processor, performs the steps in the above-described method for video data generation and storage embodiments.

The embodiments of the present application provide a computer program that can be executed by a processor to perform the steps in the embodiments of the method for video data generation and storage described above.

The embodiments of the present application provide a computer program product including a computer program which, when executed by a processor, carries out the steps of the embodiments of the method for video data generation and storage described above.

It should be noted that the above-mentioned embodiments illustrate rather than limit the present application, and that a person skilled in the art will be able to design alternative embodiments without departing from the scope of the appended claims. In the claims, any reference signs placed between parentheses shall not be construed as limiting the claim. The present application can be implemented by means of hardware including several distinct elements, and by means of a suitably programmed computer. The steps in the above-described embodiments, unless otherwise specified, should not be construed as limiting the order of execution.

What is claimed is:

1. A method for video data generation and storage implemented by a camera device, the method comprising:
capturing an image of a monitored area by an image capturing unit of the camera device;
controlling a video encoding unit of the camera device to encode the image with a first resolution, a first frame rate and a first bitrate to obtain a first bitstream;
controlling the video encoding unit to perform parallel encoding on the image with a second resolution, a second frame rate and a second bitrate to obtain a second bitstream, wherein the second resolution is greater than the first resolution, the second frame rate is greater than or equal to the first frame rate, and the second bitrate is greater than the first bitrate;
encapsulating the first bitstream into a first video and storing the first video to a storage unit; and
encapsulating the second bitstream into a second video when detecting an intrusion target in a monitored area, and storing the second video to the storage unit.

2. The method according to claim 1, wherein the camera device comprises a first buffer for temporarily storing the first video bitstream, and the method further comprises:
storing the first bitstream to the first buffer;
if the first buffer is insufficient to store the first bitstream,
overwriting the earliest first bitstream stored in the first buffer with the first bitstream to be stored; or
removing the earliest stored data from the first buffer, and storing the first bitstream in the first buffer.

3. The method according to claim 2, wherein the storage unit is a memory card of the camera device, and the encapsulating the first bitstream into a first video and storing the first video to a storage unit comprises:
acquiring the first bitstream from the first buffer;
encapsulating the first bitstream into the first video; and
storing the first video to the memory card.

4. The method according to claim 2, further comprising:
in response to a request for real-time viewing of the first bitstream sent by an electronic device, acquiring the latest first bitstream stored in the first buffer, and transmitting the latest first bitstream to the electronic device to decode the latest first bitstream and play the decoded first bitstream, wherein the electronic device is communicatively connected to the camera device.

5. The method according to claim 1, wherein the camera device further comprises a second buffer for temporarily storing the second video bitstream, and the method further comprises:
storing the second bitstream to the second buffer;
if the second buffer is insufficient to store the second bitstream,
overwriting the earliest second bitstream stored in the second buffer with the second bitstream to be stored; or
removing the earliest stored data from the second buffer, and storing the second bitstream in the second buffer.

6. The method according to claim 5, wherein the storage unit is the memory card of the camera device, and the encapsulating the second bitstream and storing the second video to the storage unit comprises:
retrieving the second bitstream from the second buffer when detecting the intrusion target in the monitored area;
encapsulating the retrieved second bitstream into the second video; and
storing the second video to the memory card.

7. The method according to claim 5, further comprising:
if the intrusion target is detected in the monitored area starting from a first moment, retrieving the second bitstream within a first duration that is prior to and closest to the first moment from the second buffer, and encapsulating the retrieved second bitstream into the second video;
if the intrusion target is detected leaving the monitored area starting from a second moment, retrieving the second bitstream within a second duration after and closest to the second moment from the second buffer, and encapsulating the retrieved second bitstream into the second video.

8. The method according to claim 5, further comprising:
in response to a request for real-time viewing of the second bitstream sent by an electronic device, acquiring the latest second bitstream from the second buffer, and transmitting the latest second bitstream to the electronic device to decode the latest second bitstream and play the decoded second bitstream, wherein the electronic device is communicatively connected to the camera device.

9. The method according to claim 2, wherein the storage unit is a hard disk in the network video recorder communicatively connected to the camera device, and the network video recorder further comprises a third buffer for temporarily storing the first bitstream; and
wherein the encapsulating the first bitstream into a first video and storing the first video to a storage unit comprises:
acquiring the first bitstream from the first buffer, and storing the first bitstream in the third buffer;
if the third buffer is insufficient to store the first bitstream, overwriting the earliest first bitstream stored in the third buffer with the first bitstream to be stored; or removing the earliest stored data from the third buffer, and storing the first bitstream to in the third buffer; and
acquiring the first bitstream from the third buffer, encapsulating the first bitstream into the first video, and storing the first video to the hard disk.

10. The method according to claim 9, further comprising:
in response to a request for real-time viewing of the first bitstream sent by an electronic device, acquiring the latest first bitstream from the third buffer, and transmitting the latest first bitstream to the electronic device to decode the latest first bitstream and play the decoded first bitstream, wherein the electronic device is communicatively connected to the network video recorder.

11. The method according to claim 5, wherein the storage unit is a hard disk in the network video recorder communicatively connected to the camera device, and the network video recorder further comprises a fourth buffer for temporarily storing the second bitstream;
wherein the encapsulating the second bitstream into a second video and storing the second video to the storage unit comprises:
acquiring the second bitstream from the second buffer, and storing the second bitstream in the fourth buffer;
if the fourth buffer is insufficient to store the second bitstream, overwriting the earliest second bitstream first from the fourth buffer with the second bitstream to be stored; or removing the earliest stored data first from the fourth buffer, and storing the second bitstream in the fourth buffer; and
retrieving the second bitstream from the fourth buffer when detecting the intrusion target in the monitored area;
encapsulating the retrieved second bitstream into the second video; and
storing the second video to the hard disk.

12. The method according to claim 11, further comprising:
in response to a request for real-time viewing of the second bitstream sent by an electronic device, acquiring the latest second bitstream from the fourth buffer, and transmitting the latest second bitstream to the electronic device to decode the latest second bitstream and play the decoded second bitstream, wherein the electronic device is communicatively connected to the network video recorder.

13. A camera device, comprising:
an image capturing unit being configured to acquire an image of a monitored area;
a video encoding unit being connected to the image capturing unit, and configured to perform encoding on the image captured by the image capturing unit; and
a controller being connected to the video encoding unit, and configured to execute a computer program stored in a memory of the controller to:
control the video encoding unit to encode the image with a first resolution, a first frame rate and a first bitrate to obtain a first bitstream;
control the video encoding unit to perform parallel encoding on the image with a second resolution, a second frame rate and a second bitrate to obtain a second bitstream, wherein the second resolution is greater than the first resolution, the second frame rate is greater than or equal to the first frame rate, and the second bitrate is greater than the first bitrate;
encapsulate the first bitstream into a first video and storing the first video to a storage unit; and
encapsulate the second bitstream into a second video when detecting an intrusion target in the monitored area, and store the second video to the storage unit.

14. The camera device according to claim 13, wherein the apparatus further comprises a first buffer for temporarily storing the first video bitstream, and the controller executes the computer program further to:
store the first bitstream to the first buffer if the first buffer is sufficient to store the first bitstream; or
if the first buffer is insufficient to store the first bitstream, overwrite the earliest first bitstream stored in the first buffer with the first bitstream to be stored; or removing the earliest stored data from the first buffer and storing the first bitstream in the first buffer.

15. The camera device according to claim 14, wherein the storage unit is a memory card of the camera device, and the controller executes the computer program further to:
acquire the first bitstream from the first buffer;
encapsulate the first bitstream into the first video; and
store the first video to the memory card.

16. The camera device according to claim 13, wherein the apparatus further comprises a second buffer for temporarily storing the second video bitstream, and the controller executes the computer program further to:
store the second bitstream to the second buffer if the second buffer is sufficient to store the second bitstream; or
if the second buffer is insufficient to store the second bitstream, overwrite the earliest second bitstream stored in the second buffer with the second bitstream to be stored; or remove the earliest stored data from the second buffer, and store the second bitstream in the second buffer.

17. The camera device according to claim 16, wherein the storage unit is the memory card of the camera device, and the controller executes the computer program further to:
retrieve the second bitstream from the second buffer when detecting the intrusion target in the monitored area;
encapsulate the retrieved second bitstream into the second video; and
store the second video to the memory card.

18. The camera device according to claim 16, wherein the controller executes the computer program further to:
if the intrusion target is detected in the monitored area starting from a first moment, retrieve the second bitstream within a first duration that is prior to and closest to the first moment from the second buffer, and encapsulating the retrieved second bitstream into the second video;
if the intrusion target is detected leaving the monitored area starting from a second moment, retrieve the second bitstream within a second duration after and closest to the second moment from the second buffer, and encapsulate the retrieved second bitstream into the second video.

19. The camera device according to claim 16, wherein the controller executes the computer program further to:
in response to a request for real-time viewing of the second bitstream sent by an electronic device, acquire the latest second bitstream from the second buffer, and transmit the latest second bitstream to the electronic device to decode the latest second bitstream and play the decoded second bitstream, wherein the electronic device is communicatively connected to the camera device.

20. A video surveillance system, comprising: a camera device, and a network video recorder communicatively connected to the camera device, wherein the camera device comprises:
an image capturing unit being configured to acquire an image of a monitored area;
a video encoding unit being connected to the image capturing unit, and configured to perform encoding on the image captured by the image capturing unit; and
a controller being connected to the video encoding unit, and configured to execute a computer program stored in a memory of the controller to:
control the video encoding unit to encode the image with a first resolution, a first frame rate and a first bitrate to obtain a first bitstream;
control the video encoding unit to perform parallel encoding on the image with a second resolution, a second frame rate and a second bitrate to obtain a second bitstream, wherein the second resolution is greater than the first resolution, the second frame rate is greater than or equal to the first frame rate, and the second bitrate is greater than the first bitrate;
encapsulate the first bitstream into a first video, and storing the first video to a storage unit; and
encapsulate the second bitstream into a second video when detecting an intrusion target in the monitored area, and store the second video to the storage unit.
